(19) United States
(12) Patent Application Publication
(10) Pub. No.: US 2010/0132153 A1
(43) Pub. Date: Jun. 3, 2010

(54) CLEANABLE FILTER SYSTEM

(75) Inventors: Hans Leibold, Malsch (DE); Ingo Muellner, Karlsruhe (DE)

Correspondence Address: Darby & Darby, P.O. Box 770, Church Street Station, New York, NY, 10008-0770, US

(73) Assignee: Forschungszentrum Karlsruhe GmbH, Karlsruhe (DE)

(21) Appl. No.: 12/444,520

(22) PCT Filed: Sep. 28, 2007
(86) PCT No.: PCT/EP07/08454

§ 371 Date: Feb. 5, 2010

(30) Foreign Application Priority Data
Oct. 6, 2006 (DE) 10 2006 047 284.5

(51) Int. Cl. A47L 9/10; B01D 46/02; B01D 46/52; B01D 46/04

(52) U.S. Cl. 15/347; 55/294

(57) ABSTRACT

A cleanable filter system includes a filter housing having an inlet for dust-laden gas and an outer annular gap volume disposed about an inner volume. The inner volume and the outer annular gap volume extend axisymmetrically about a bisecting line and are separated from one another by at least one gas-permeable wall. A submicron particulate filter is disposed in the inner volume. A discharge pipe is sealingly disposed in the inner volume axisymmetrically about the bisecting line. The discharge pipe includes a peripheral cylindrical surface that is gas-permeable and covered by the submicron particulate filter. A purge-gas conduit is disposed in the discharge pipe and configured to be rotationally driven about the bisecting line. The purge-gas conduit includes at least one radially outwardly directed nozzle disposed in a region of the submicron particulate filter.

### CROSS REFERENCE TO PRIOR APPLICATIONS

This application is a U.S. National Phase application under 35 U.S.C. §371 of International Application No. PCT/EP2007/008454, filed on Sep. 28, 2007, and claims benefit to German Patent Application No. DE 10 2006 047 284.5, filed on Oct. 6, 2006. The International Application was published in German on Apr. 17, 2008 as WO 2008/043440 under PCT Article 21(2).

### FIELD

The present invention relates to a cleanable filter system for dust-laden gases, preferably for use in industrial and household vacuum cleaners.

### BACKGROUND

Cleanable filter systems are known from filtration technology such as stationary submicron particulate filters, for example. These filter surfaces, which are gradually clogged during operation with suspended matter, such as dust, are typically cleaned using cleaning methods whereby a direct flow of clean gas traverses the filter surfaces at an elevated pressure, often in a pulsed operation in the counterflow, thereby loosening the filter load (accumulated particulate matter) all at once from the filter surfaces. The requisite pressure impulses are input at the clean-gas side, preferably using a purge gas via nozzle systems. The loosened filter cakes are collected on the raw gas side in that they are directed to corresponding collection regions, for example. However, filter systems equipped in this manner entail a certain outlay for equipment, making them typically unsuited for a reliable or economic use in relatively small filter systems.

Also known, on the other hand, are smaller filter systems for dust-laden gases in industrial or private environments, such as exhaust ventilation systems, vacuum cleaners, air-circulation filters, exhaust-gas filters (Diesel particulate filters), for example, which are often not operated in continuous operation or which only clog after extended use. In these systems, it is often not appropriate or practical to clean the filter surfaces or to collect the filter load. Instead of undergoing a cleaning process, the filter surfaces or entire filter systems are typically replaced (for example, vacuum cleaner bags), or the filter load is thermally or chemically broken down (for example, Diesel particulate filters).

In the case of industrial vacuums (for example, of the kind manufactured by companies such as Nilfisk and Karcher), filter cartridges are used, which are completely disassembled at defined intervals and must be mechanically cleaned outside of the suction apparatus, for example blown out using compressed air or flushed with a scavenging fluid. The cleanable filter media do not have a submicron particulate filter quality and, therefore, to a considerable degree, allow the problematic fine dust to pass through. However, they are suited for applications that entail large dust quantities, and they do not become clogged all too quickly. These filter systems sometimes have other secondary fine-particulate filters or submicron particulate filters configured downstream therefrom, for example, for allergenic and/or toxic dusts.

Filter cartridges of this kind have a comparatively large filter surface area and thus can be operated for a length of time at high dust concentrations. The filter systems have comparatively large dimensions, including a large-volume dust-collecting space. Submicron particulate filters accelerate the clogging of the entire filter system and are only added as secondary one-way filters to meet special requirements, such as when authorization is sought for handling toxic dusts. This also leads to an increased energy consumption, a reduced separation effect in the fine-dust region, and a limited service life.

Vacuum cleaners are increasingly becoming commercially available which are equipped with a mechanical separator stage for separating off the better part of the dust quantity in a dust-collecting receptacle, a secondary one-way fine-dust filter, as well as additional filter stages. The consequence is a high pressure loss in the filter system which increases further with every filter stage. For that reason, the systems require more energy with every filter stage. Examples of this include systems from companies such as: Dyson having a cyclone separator (up to 12 cyclones in parallel), Bosch-Siemens VS08G2020 having a vortex tube separator, as well as Philips Marathon having what is commonly known as cyclone filter technology.

Cleanable filter systems are available from manufacturers such as AEG for household vacuum cleaners having what is commonly referred to as TWIN CLEAN technology, from Nilfisk for industrial vacuums having the XTREMECLEAN technology, and from various manufacturers of industrial suction apparatuses having the rotary nozzle technology described above.

As a general principle, vacuum cleaner systems having only mechanical separation only hold back a very small proportion of the fine dust. In addition, the separation efficiency is also a function of the volumetric air flow, i.e., the most efficient separation is achieved at maximum volumetric air flow.

Rotary nozzle systems are used for industrial vacuums, welding-emission extractors, inter alia. Systems of this kind are preferably operated using compressed air and require a substantial installation volume; therefore, they are not suited for the requirements of compact vacuum cleaners or for fine dust.

In the case of the aforementioned TWIN CLEAN technology, two identical cartridge filters of filter class H10, i.e., of the lowest submicron particulate filter stage, are used; for the cleaning operation, it is necessary to interrupt the suction process and replace the filter on site. The loaded filter is then suction cleaned in some areas when the vacuum cleaner is turned on again, it being necessary to rotate the same by hand. Subsequently thereto, the cleaned filter can be used again. Apart from the fact that this system is only suited on a limited basis for holding back fine dust, it requires interrupting the operation of this system to clean the filter.

Also in the case of the mentioned XTREMECLEAN technology, a filter cartridge is subdivided internally and, in each case, only one half of the (coarse filter) filter cartridge functions in suction operation while the other half is being cleaned. The system switches over every 30 seconds, and the second half is cleaned while the first half filters. Thus, the volumetric purge flows correspond to the volumetric suction flows and are comparatively low. Moreover, at any one time, only one half of the installed filter surface area is available for the filtration process.

### SUMMARY

In an embodiment, the present invention provides a cleanable filter system including a filter housing having an inlet for dust-laden gas and an outer annular gap volume disposed about an inner volume. The inner volume and the outer annular gap volume extend axisymmetrically about a bisecting line and are separated from one another by at least one gas-permeable wall. A submicron particulate filter is disposed in the inner volume. A discharge pipe is sealingly disposed in the inner volume axisymmetrically about the bisecting line. The discharge pipe includes a peripheral cylindrical surface that is gas-permeable and covered by the submicron particulate filter. A purge-gas conduit is disposed in the discharge pipe and configured to be rotationally driven about the bisecting line. The purge-gas conduit includes at least one radially outwardly directed nozzle disposed in a region of the submicron particulate filter.

### BRIEF DESCRIPTION OF THE DRAWINGS

The present invention is explained in greater detail in the following with reference to an exemplary embodiment on the basis of figures, which show exemplarily:

FIG. 1: a schematic sectional view from the side;

FIG. 2: a schematic sectional plan view of a cleanable filter system for dust-laden gases;

FIG. 3: a cross section of a submicron particulate filter including a fold pack having a uniform fold height; and

FIG. 4a through c: the cross sections of submicron particulate filters including a fold pack having varying fold heights.

### DETAILED DESCRIPTION

In an embodiment, the present invention provides a cleanable submicron particulate filter system for fine dust-laden gas having a compact design and, in general, a low pressure loss and allowing a filter cleaning without necessitating interruption of the suction process. It is intended that the system be especially suited for a use in vacuum cleaner systems.

As dust-laden gases, dry fluids are named, in particular, in the context of this invention; i.e., both the gas, as well as the particle component (dust) suspended therein are dry gases or solid matter. They do not have any liquid components and are thus distinguished from aerosols, mists or vapors.

In an embodiment, the present invention provides a cleanable filter system for dust-laden gas, where the gas is directed via suction means through a gas-permeable wall used as a coarse filter to hold back coarse dust and objects, subsequently through a submicron particulate filter and, from there, to a discharge pipe. Thus, the system preferably includes only two filter stages, the coarse filter (prefilter) and a submicron particulate filter, so that a low pressure loss may be advantageously provided.

In an embodiment, the submicron particulate filter is not cleaned during interruption of the filter operation, but rather in a segmental manner, cyclically by a counterflow, a purge gas being directed via a nozzle arrangement from the clean gas side through the filter surface.

The submicron particulate filter is preferably cylindrical and includes an outer raw gas region and an inner clean gas region; the nozzle, which is disposed in a radially outwardly directed configuration, cyclically traverses the individual segments of the submicron particulate filter with a rotary motion about the bisecting line of the cylinder. A relative rotary motion between the nozzle and the inner cylindrical surface of the submicron particulate filter is also provided. In this context, in principle, both components, the nozzle and the submicron particulate filter, are configurable to be rotatable about the bisecting line. This may be preferably realized, but, in the context of the present invention, not in a manner that is limiting to this one specific embodiment, by using a rotary, peripherally extending nozzle and a stationary submicron particulate filter. In another embodiment, the rotary motion and the counterflow of the purge gas (cleaning gas) in the nozzle are continuous in each case. There is no need for a control algorithm for this purpose.

The purge gas is supplied in a purge gas line (purge gas conduit) that is preferably configured in the discharge pipe and rotates about the bisecting line. The nozzle is preferably disposed at a sealed end of the purge gas line, is directed there radially outwardly and tangentially covers preferably a fold or a segment of the submicron particulate filter, axially over the entire height thereof.

To provide a more effective inflow of the purge gas stream from the nozzle into the submicron particulate filter, the nozzle rim design includes a sliding seal (for example, a rubber wiper).

The filter surfaces of the preferably cylindrical submicron particulate filter are planar, i.e., cylindrically curved or cylindrically curved as a fold pack (corrugated or pleated); the inwardly directed, clean-gas side filter surfaces, respectively fold ends preferably being applied in a planar manner to a cylindrical, gas-permeable peripheral surface or forming the same. In this context, the fold ends on the peripheral surface are preferably spaced apart at an unvarying distance from one another. The gas-permeable peripheral surface is preferably part of a discharge pipe.

The cleanable filter element is sealingly inserted, together with the discharge pipe, into a raw gas-side inner volume of the filter system. The cleaned dust (filter load) is blown back in the counterflow into this inner volume where it sedimentates to the bottom in a dust collection volume preferably disposed at the bottom.

The prefilter is preferably configured as a gas-permeable wall radially about the submicron particulate filter, preferably as perforated sheet metal, wire grating, flexible mesh or porous plate formed as the outside cylinder surface. On the one hand, the distance between the wall and the submicron particulate filter must not impede the removal of the cleaned filter load. However, the advantage of a small distance is that the counterflow not only traverses the submicron particulate filter, but also the prefilter (coarse filter) and cleans the same in the counterflow.

The purge gas stream (counterflow, cleaning gas) is preferably branched off from the cleaned clean gas, for example, from the discharge pipe, and compressed as purge gas stream for the cleaning operation.

The gas-permeable wall (prefilter) preferably has a mesh aperture (or a width or diameter of the gas passages, such as holes of a perforated sheet metal) larger than that of the submicron particulate filter, the gas-permeable wall also being preferably permeable to the dust, in particular to the finer dust.

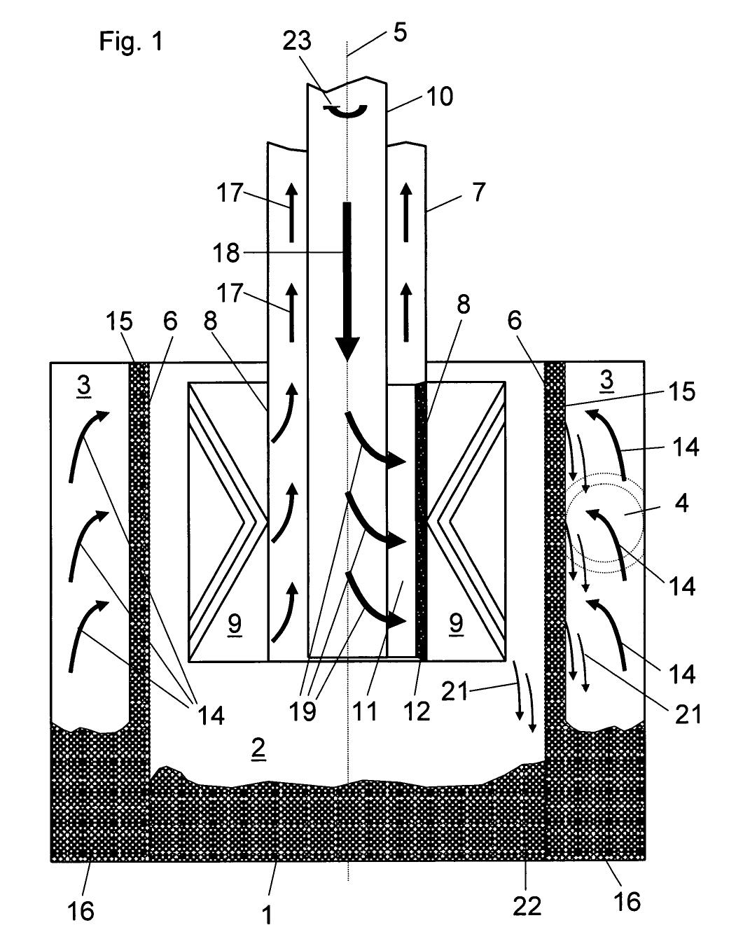

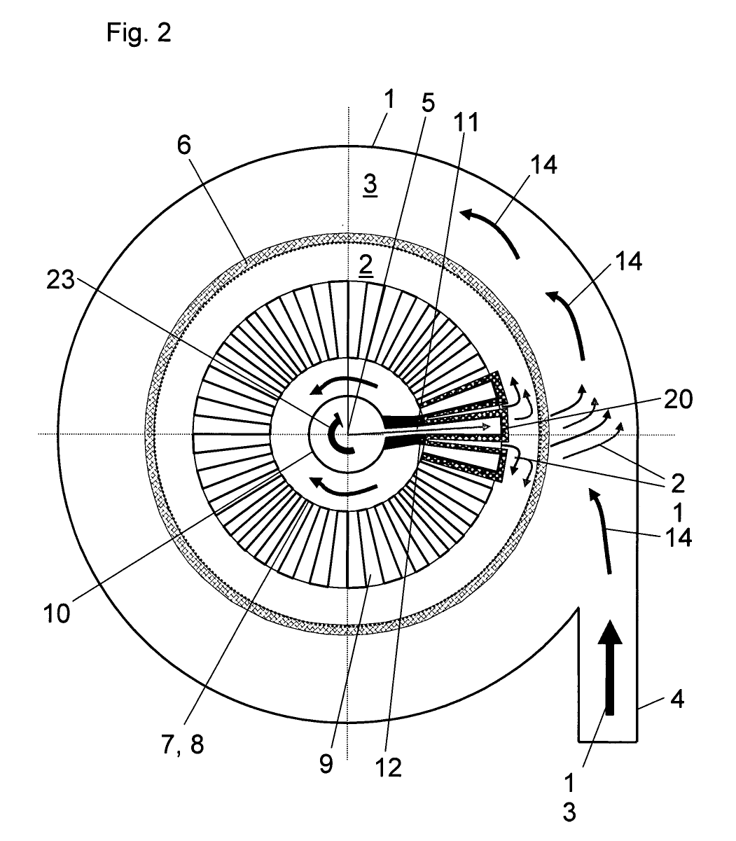

The cleanable filter system for dust-laden gases illustrated in FIGS. 1 and 2 includes a filter housing 1 having an inner volume 2 and an outer annular gap volume 3 disposed about the same and having an inlet 4 for dust-laden raw gas 13, inner volume 2 and annular gap volume 3 extending axisymmetrically about a bisecting line 5 and being separated from one another by a gas-permeable wall, i.e., prefilter 6.

Raw gas 13 arrives from preferably tangentially inwardly directed inlet 4, into annular gap volume 3, an annular flow 14 forming therein. Prefilter 6, preferably a perforated sheet metal or a wire grating, does not directly receive the oncoming flow. Consequently, relatively large particles or impurities are not pressed by the gas stream at an obtuse angle into the openings in the wall, thereby minimizing any risk of clogging. The annular flow must also be deflected for the passage through prefilter 6. In terms of fluid dynamics, heavier particles and larger impurities are not able to be deflected in this manner due to their greater deflection inertia, and are, therefore, separated out. In addition, the annular flow prevents relatively large prefilter loads 15 from forming. The particle fractions separated off from the raw gas in the annular gap volume, particularly at the prefilter, sedimentate to the bottom in the annular gap volume in dust-collection annular volume 16 and may be removed from there by other means (not shown).

In addition, the cleanable filter system of the illustrated specific embodiment includes a discharge pipe 7 that projects axisymmetrically about bisecting line 5 sealingly into inner volume 2 and is sealed therein at the extremity, preferably at the lower end (compare FIG. 1), peripheral cylindrical surfaces 8 of the discharge pipe being gas-permeable in the inner volume and being annularly covered by a corrugated submicron particulate filter 9. The raw gas that is precleaned in prefilter 6 enters as clean gas 17 through submicron particulate filter 9 and gas-permeable peripheral cylindrical surfaces 8 into the interior of discharge pipe 7 and is removed therein by a fan (compressor) that is connected on the suction side.

In the fan, the clean gas undergoes a pressure increase that purge gas stream 18 is able to utilize to clean submicron particulate filter 9 in the counterflow. The purge gas stream 18 is preferably a gas substream that is branched off from clean gas 17 after passing through the fan. This gas substream is directed through a purge gas line 10 and, following gas deflection 19, through a nozzle 11, and through submicron particulate filter 9 during running filter operation, the pressure piling of the purge gas stream in comparison with the precleaned raw gas effecting a local reversal of the flow direction in the submicron particulate filter and removing submicron particulate filter cake 20 there.

For the cleaning process, the illustrated filter system includes a purge-gas conduit 10 that is rotationally configured and driven in discharge pipe 7 about bisecting line 5, including at least one radially outwardly directed nozzle 11 in the region of submicron particulate filter 9. Together with the nozzle and purge gas line 10, the nozzle orifice rotates with a rotary motion 23 over the inner side of gas-permeable peripheral cylindrical surface 8 and is preferably sealed against the same by a sliding seal 12 in order to avoid a secondary flow.

As illustrated in FIG. 2, the nozzle orifice is configured to provide an inflow into a fold pleating of the submicron particulate filter 9 that is as unimpeded as possible. This is preferably achieved by providing a spacing between two inwardly disposed fold ends corresponds to the nozzle width (compare FIG. 2), and in that the nozzle height corresponds to the height of the submicron particulate filter (compare FIG. 1). This creates an additional back pressure in the fold which likewise acts against the lateral filter surfaces between the fold ends, thereby providing a cleaning effect. A stepwise rotary motion 23 produced by a stepper motor additionally optimizes the cleaning operation in that, in the case of a preferred control, the dwell times of the nozzle are prolonged directly in front of the folds and are shortened directly in front of the fold ends. A further improvement is achieved by a possible counter synchronization of the pressure of purge gas stream 18 in the region of gas deflection 19 at the rotational speed of nozzle 11, for example, by employing piezoelectric actuators in purge gas line 10 that are oriented to the nozzle orifice.

In a cleaning operation, both submicron particulate filter 9, as well as prefilter 6 are preferably traversed by the flow of the same purge gas stream (compare filter-cake flow direction 21), submicron particulate filter cake 20 preferably settling in bottom collection region 22 of inner volume 2.

Thus, the present invention presents a cleanable filter system which is regenerative through the use of cleaned air (clean-gas back flow). It is thus possible to do without purely mechanical separators, such as cyclones or vortex separators, which may, in fact, be continuously operated, but exhibit a low separation efficiency, while at the same time requiring increased power. It is likewise possible to eliminate the need for conventional dust bags, which must be replaced on a regular basis, allow the passage of airborne particulates and, in addition, entail substantial operating costs.

The continuous cleaning of the filter system, in particular of submicron particulate filter 9 during continuous suction operation, by a rotating scavenging device of the aforementioned type, which is guided sealingly over the clean-air side over the extent of the submicron particulate filter and, in the process, briefly establishes a continuous connection between the scavenging device and one or more folds of the dust-laden filter medium, constitutes an important operational advantage for vacuum cleaners.

Prefilter 6 is used for holding back relatively large particles. It causes a minimal additional pressure loss in the system and is simultaneously used as mechanical protection for submicron particulate filter 9.

Due to the continuous cleaning, the pressure loss across submicron particulate filter 9 advantageously remains relatively constant, fluctuating only within very narrow limits. Thus, the suction power of the vacuum cleaner likewise remains constant and is not reduced in response to the loading of the filters that are used.

For the cleaning process, the cleaned exhaust air, but also precleaned air from the ambient environment may be used, and supplied by a common fan (suction device or fan) or possibly by an additional fan.

The filter system makes it possible for the entire particle spectrum of the dust, in particular of the fine dust as well, to be advantageously separated in one single filter stage, namely at submicron particulate filter 9, under typical vacuum cleaner conditions.

The separated dust is removed in a sedimented form, that is preferably compressed by a dust collection bag which includes collection region 22 and dust-collection annular volume 16 (for example, dust collection bag that is attached to housing 1 at the bottom); is removed from the filter system and directed to a removal site in a nonpolluting and hygienic process. There is no longer a need for a frequent and thus cost-intensive replacing of conventional types of dust bags, and one does not have to forgo important advantages, such as in particular, the hygienic removal of the collected dust.

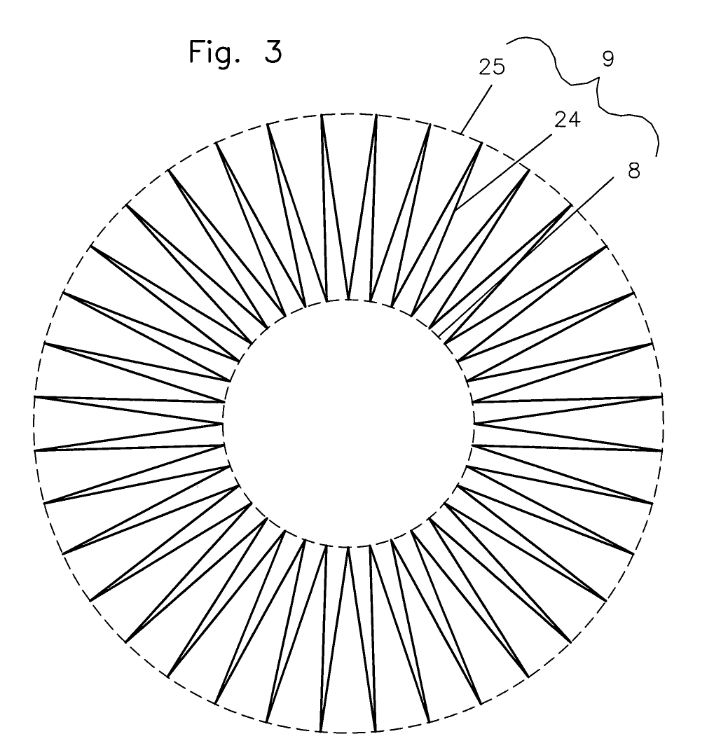

FIG. 3 depicts the horizontal cross section of a submicron particulate filter 9 having gas-permeable peripheral cylindrical surface 8, as well as an optional outer peripheral surface 25 used for guidance of filter element 24. The perspective corresponds to the cross section of FIG. 2. In this embodiment, all folds in the fold pack of the filter element have a uniform height. The end faces of the filter elements are preferably bonded to annular end elements in a manner that inhibits flow; in their dimensions, these end elements spanning the surface between inner peripheral cylindrical surface 8 and outer peripheral surface 25.

Within the context of the present invention, the concepts of folds, fold heights and fold packs not only include pleated or corrugated, bent filter surfaces (for instance, bent or stretched about a reinforcement), but also fold packs composed of unfolded individual filter elements with or without additional connecting elements, such as guide strips.

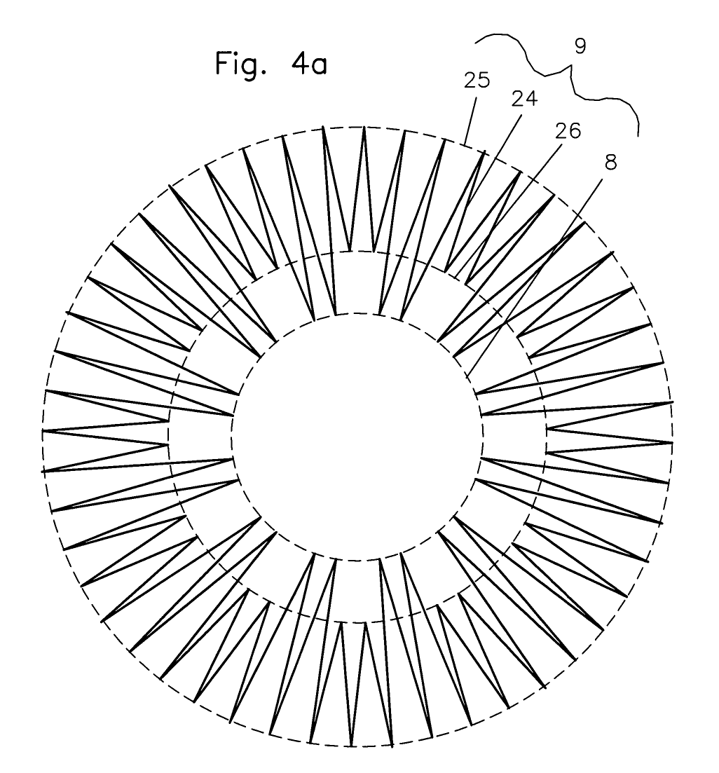

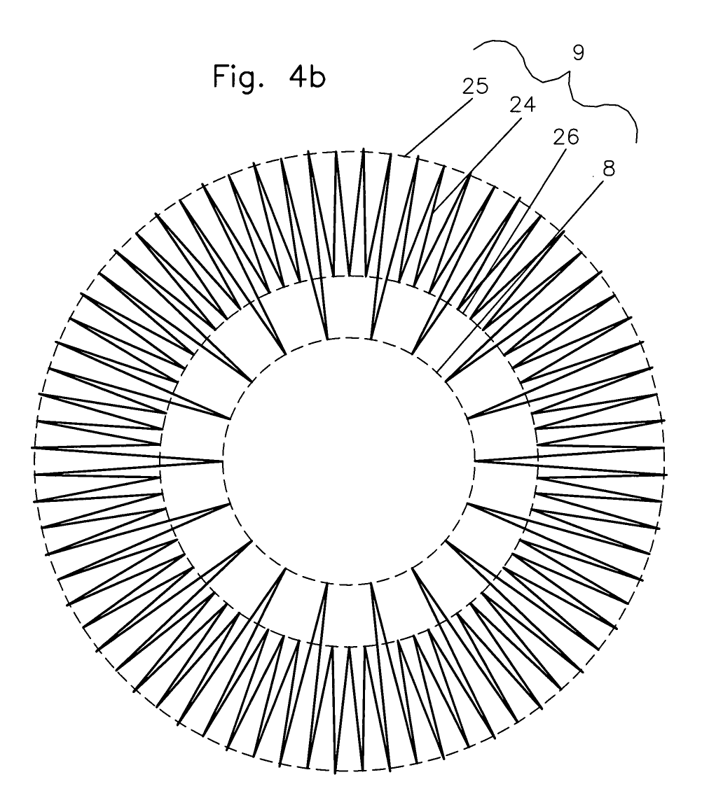

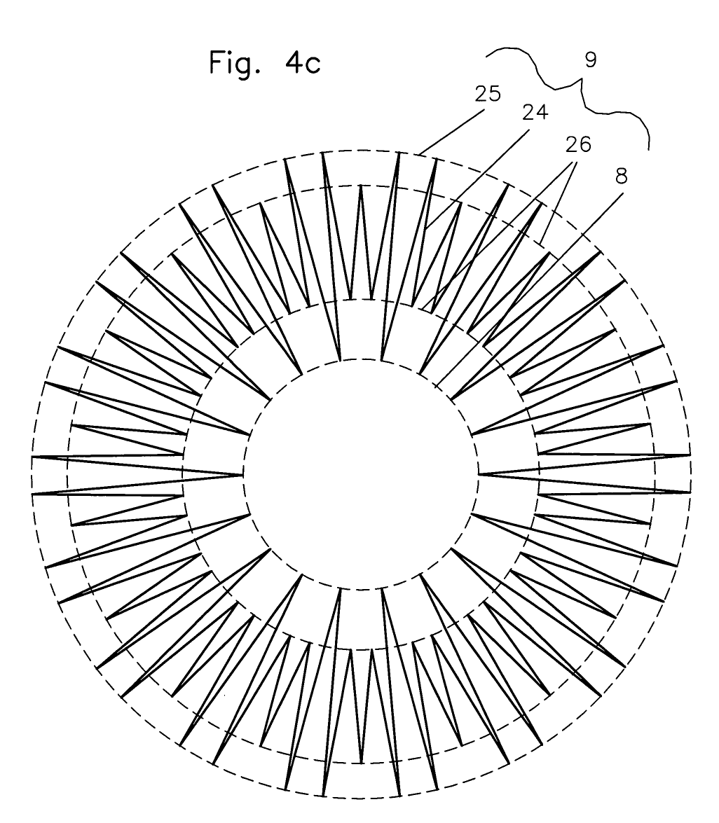

FIG. 4a through c show specific embodiments having different fold heights. However, as in the case of the specific embodiment illustrated in FIG. 3, filter elements 24 illustrated here also have periodically folded filter surfaces or circumferential filter surfaces which are composed, for example, of unfolded individual filter surfaces alternately featuring inwardly and outwardly disposed fold ends. In this context, the fold ends extend both to an inner peripheral cylindrical surface 8, as well as to an outer peripheral surface 25 of the filter element, as well as in the case of the specific embodiments in accordance with FIG. 4a through c, to an intermediate circumferential surface 26 disposed therebetween.

At least the inwardly disposed fold ends of filter element 24 feature a reinforcement which prevents the fold pack from giving way or helps to avoid the same. Preferably used as reinforcement are the gas-permeable, inner peripheral cylindrical surface 8 (for example, sheet metal having perforations) as a separate component, an impregnation of the fold ends using a polymer, a tensioned wire or reinforcement strips that are inwardly or outwardly joined to the fold. The reinforcements, which are configured on the inner peripheral surface, are preferably designed as sliding seal bands, or the inner peripheral surface is formed by a sheet metal having perforations. Reinforcements on an intermediate surface 26 preferably include a rod-shaped object, such as a tensioned wire, for example, that is inserted into each of the fold ends, or, alternatively, a polymer impregnation.

The outer peripheral surface is optionally formed by another separate filter surface having a larger mesh aperture than the filter surface, i.e., that is functionally formed as a prefilter (for example, perforated sheet metal). Thus, not only is a further prefiltering achieved, but an additional, external bracing of the fold pack and thus a relieving of the aforementioned reinforcements is advantageously accomplished as well.

Preferably and as is customary, particularly in the case of household vacuum cleaners, submicron particulate filters 9 are provided as filter cartridges in the filter system and are replaceable as a whole. In this context, the preferably provided separate filter surface at the outer peripheral surface advantageously provides additional protection against external mechanical action.

Alternatively to the aforementioned outer peripheral surface as a separate filter surface, the outer fold ends may also be stabilized or strengthened, for example, using the aforementioned reinforcements, in order to provide additional filter stability in a different manner as well.

FIGS. 4a and b each show a specific embodiment where only inwardly disposed fold ends extend to an intermediate surface 26. The W-fold illustrated in its basic form in FIG. 4a allows the annulus volume between inner and outer peripheral surface to be utilized more effectively since the inward folding of additional filter surface on a given annular surface is made possible. At the same time, the fold height between the two mentioned peripheral surfaces may be substantially increased. Both measures render possible a filter surface of filter element 24 that is enlarged by up to 60-80%. The folds all preferably exhibit the same fold spacing on the outer peripheral surface. A narrowing of folds no longer occurs. Thus, the filtered dust is able to be removed much more effectively.

Introducing an inwardly directed W-fold (compare FIGS. 4a and b) also makes it possible to optimize the oncoming flow. This makes it possible to accommodate not only substantially larger and, nevertheless, completely accessible filter surfaces in a filter element, but also to realize a defined pressure loss, as well as a defined through-flow velocity over the entire filter surface, and thus a more uniform loading of the filter surfaces. Preferably, the distances between the fold ends at inner peripheral cylindrical surface 8 and outer peripheral surface 25 are the same, as are likewise the intermediate spaces between the filter surfaces in the fold pack, in order to provide a better oncoming flow for the filter, the fold ends, in turn, preferably not being bent to form sharp edges, but rather being folded to achieve a minimum distance between the filter surfaces, at a specific radius equal to half of the minimum distance.

In addition, FIG. 4c shows another specific embodiment of a cleanable filter system, only outwardly disposed fold ends extending to a second intermediate surface 26. In the illustrated variant, for example, only two out of three outwardly oriented fold ends end periodically at outer peripheral surface 25. Such a design also makes it possible to optimize the way out for the dust of the filter load loosened during a cleaning, for example, by a targeted flow path expansion through the use of an expansion nozzle or an additional vortexing chamber, thereby making it more difficult for the cleaned filter regions of the particular segment to be clogged again. In the same way, this type of design deflects the cleaning flow toward prefilter 6 (compare FIGS. 1 and 2), thereby making it more difficult for it to be directly diverted to adjacent segments of the filter element used in normal filter operation.

As a general principle, illustrated intermediate surfaces 26, as well as outer and inner peripheral surfaces 25, 8, respectively, are concentrically disposed axially symmetrically to one another, i.e., they extend in the manner of submicron particulate filter 9 about a common bisecting line 5.

Instead of one preferred cylindrical configuration of all of the mentioned peripheral surfaces and intermediate surfaces, other specific embodiments include at least one of these surfaces, which does not have a cylindrical, but rather preferably a frustoconical design, the cross sections basically resembling those illustrated in FIG. 2 through 4, and the aforementioned concentric configuration of these surfaces relative to one another being retained.

In the case of a vertical configuration of the filter element, the loosened filter load is necessarily gravimetrically enriched in response to a cleaning in the bottom region. By providing a variant, preferably widening configuration of the flow paths in this very region, for example, by a downwardly converging frustoconical formation of the intermediate surfaces for outer fold ends, it is possible to influence and preferably also avoid a redeposition of the loosened filter load on the freshly cleaned filter surfaces.

The present invention is not limited to the embodiments described herein; reference should be had to the appended claims.

### LIST OF REFERENCE NUMERALS

1 filter housing
2 inner volume
3 annular gap volume
4 inlet
5 bisecting line
6 prefilter
7 discharge pipe
8 gas-permeable peripheral cylindrical surface
9 submicron particulate filter
10 purge gas line
11 nozzle
12 sliding seal
13 raw gas
14 annular flow
15 prefilter load
16 dust-collection annular volume
17 clean gas
18 purge gas stream
19 gas deflection
20 particulate filter cake
21 filter cake flow direction
22 collection region
23 direction of rotation
24 filter element
25 outer peripheral surface
26 intermediate surface

1-28. (canceled)

29. A cleanable filter system for dust-laden gas, comprising:
a filter housing including an inlet for the dust-laden gas and an outer annular gap volume disposed about an inner volume, the inner volume and the outer annular gap volume extending axisymmetrically about a bisecting line and being separated from one another by at least one gas-permeable wall;
a submicron particulate filter disposed in the inner volume;
a discharge pipe sealingly disposed in the inner volume axisymmetrically about the bisecting line, the discharge pipe having a peripheral cylindrical surface that is gas-permeable and covered by the submicron particulate filter; and
a purge-gas conduit disposed in the discharge pipe, the purge-gas conduit being configured to be rotationally driven about the bisecting line, the purge-gas conduit having at least one radially outwardly directed nozzle disposed in a region of the submicron particulate filter.

30. The cleanable filter system as recited in claim 29, wherein the inlet is configured to tangentially provide the dust-laden gas into the outer annular gap volume.

31. The cleanable filter system as recited in claim 29, wherein the gas-permeable wall includes mesh apertures that are larger than apertures of the submicron particulate filter.

32. The cleanable filter system as recited in claim 31, wherein the apertures of the gas-permeable wall and the apertures of the submicron particulate filter increase in size from inside edges towards outside edges of the gas-permeable wall and the submicron particulate filter, respectively.

33. The cleanable filter system as recited in claim 31, wherein the gas-permeable wall is configured as a prefilter that is permeable to dust.

34. The cleanable filter system as recited in claim 29, wherein the submicron particulate filter includes a fold pack having at least one of folds and corrugations, the submicron particulate filter being disposed about the peripheral cylindrical surface of the discharge pipe.

35. The cleanable filter system as recited in claim 34, wherein the fold pack includes fold ends that are disposed on the peripheral cylindrical surface of the discharge pipe at an equal spacing distance from each other.

36. The cleanable filter system as recited in claim 35, wherein the nozzle has a width which does not exceed the equal spacing distance of the fold ends.

37. The cleanable filter system as recited in claim 34, wherein the fold pack includes a filter element having an inner and an outer peripheral surface and at least one intermediate circumferential surface disposed therebetween, the filter element being at least one of periodically folded and assembled so as to provide alternating inner and outer fold ends, each inner fold end having a reinforcement and being disposed on at least one of the inner peripheral surface and the intermediate circumferential surface of the filter element and each outer fold end being disposed on at least one of the outer peripheral surface and the intermediate circumferential surface of the filter element.

38. The cleanable filter system as recited in claim 37, wherein the reinforcements of the inner fold ends disposed on the inner peripheral surface of the filter element are configured as at least one of sliding seal bands and perforated sheet metal.

39. The cleanable filter system as recited in claim 38, wherein the reinforcements of the inner fold ends disposed on the intermediate circumferential surface of the filter element are each configured as a respective rod-shaped object inserted into each fold end.

40. The cleanable filter system as recited in claim 37, wherein a filter surface is provided about the outer peripheral surface of the filter element.

41. The cleanable filter system as recited in claim 37, wherein the outer fold ends are disposed on the outer peripheral surface of the filter element.

42. The cleanable filter system as recited in claim 38, wherein the outer fold ends are disposed with an equal spacing about the outer peripheral surface of the filter element.

43. The cleanable filter system as recited in claim 37, wherein the at least one intermediate circumferential surface includes first and second intermediate circumferential surfaces, the second intermediate circumferential surface being disposed between the first intermediate circumferential surface and the outer peripheral surface of the filter element, each inner fold end being disposed on at least one of the inner peripheral surface and the first intermediate circumferential surface of the filter element and each outer fold end being disposed on at least one of the outer peripheral surface and the second intermediate circumferential surface of the filter element.

44. The cleanable filter system as recited in claim 43, wherein the inner and outer peripheral surfaces and the first and second intermediate circumferential surfaces extend concentrically and are axisymmetrically disposed about a common bisecting line.

45. The cleanable filter system as recited in claim 37, wherein the submicron particulate filter includes an inner cylindrical peripheral surface.

46. The cleanable filter system as recited in claim 37, wherein the submicron particulate filter includes at least one of an outer cylindrical peripheral surface and an intermediate surface.

47. The cleanable filter system as recited in claim 37, wherein at least one of the inner peripheral surface, the at least one intermediate circumferential surface and the outer peripheral surface of the filter element is frustoconical in shape.

48. The cleanable filter system as recited in claim 37, wherein the outer peripheral surface of the filter element is configured as a prefilter.

49. The cleanable filter system as recited in claim 40, wherein the filter surface is fixed by at least one circumferential face thereof to terminating filter components of the cleanable filter system.

50. The cleanable filter system as recited in claim 49, wherein the at least one circumferential end face includes two circumferential end faces, the circumferential end faces being sealingly bonded to the terminating filter components.

51. The cleanable filter system as recited in claim 29, wherein the nozzle includes a nozzle orifice configured as a sliding seal.

52. The cleanable filter system as recited in claim 29, wherein the purge-gas conduit is configured to be rotationally driven by a step motor.

53. The cleanable filter system as recited in claim 29, wherein the purge-gas conduit is configured to connect to an outlet side of a compressor providing a continuous purge-gas stream.

54. The cleanable filter system as recited in claim 53, wherein the discharge pipe is configured to connect to a suction side of the compressor.

55. A vacuum cleaner comprising:
a suction aggregate; and
a cleanable filter system including:
a filter housing including an inlet for dust-laden gas and an outer annular gap volume disposed about an inner volume, the inner volume and the outer annular gap volume extending axisymmetrically about a bisecting line and being separated from one another by at least one gas-permeable wall;
a submicron particulate filter disposed in the inner volume;
a discharge pipe connected to the suction aggregate at a first end and sealingly disposed at a second end in the inner volume axisymmetrically about the bisecting line, the discharge pipe having a peripheral cylindrical surface that is gas-permeable and covered by the submicron particulate filter; and
a purge-gas conduit disposed in the discharge pipe, the purge-gas conduit being configured to be rotationally driven about the bisecting line, the purge-gas conduit having at least one radially outwardly directed nozzle disposed in a region of the submicron particulate filter.

56. The vacuum cleaner as recited in claim 55, wherein the suction aggregate is connected as a compressor to the purge-gas conduit.
